(19) United States
(12) Patent Application Publication
(10) Pub. No.: US 2015/0160076 A1
(43) Pub. Date: Jun. 11, 2015

(54) TEMPERATURE MEASURING APPARATUS

(71) Applicant: AQUAWAYS Co., Ltd, Taoyuan (TW)

(72) Inventors: Shih-Wen LIAO, Taoyuan (TW); Ching-Cheng WU, Taoyuan (TW); Chih-Liang FAN, Taoyuan (TW); Min- Nan LI, Taoyuan (TW)

(73) Assignee: AQUAWAYS Co., Ltd, Taoyuan (TW)

(21) Appl. No.: 14/098,693

(22) Filed: Dec. 6, 2013

(51) Int. Cl. G01K 13/00; G01K 7/16

(52) U.S. Cl. CPC G01K 13/002; G01K 7/16

(57) ABSTRACT

The present invention discloses an improved temperature measuring apparatus, which at least comprises a temperature measurement device and a mobile electronic part. The temperature measurement device is provided with a temperature sensing unit, a signal processing unit and a first transmission unit. The signal processing unit is connected with the temperature sensing unit and the first transmission unit, respectively. The mobile electronic part is provided with a second transmission unit, a control unit, a display unit and a power supply. The control unit is connected with the second transmission unit, the display unit and the power supply, respectively, and the second transmission unit is connected with the first transmission unit so as to receive a measurement result from the temperature measurement device, and the display unit displays the measurement result. Therefore, the present invention has such effects as easy operation, plug-and-play, and timely measuring.

### BACKGROUND OF THE INVENTION

1. Technical Field

The invention relates to an improved temperature measuring apparatus, and more particularly to an improved temperature measuring apparatus with easy carrying and timely measuring.

2. Description of Related Art

Accordingly, a body temperature is an indicator of human health. The healthy situation of the human immune system is presented by temperature changes of a human body. Therefore, thermometer is an essential body measuring instrument almost for every family. With the technology development, the body measuring instrument has been developed a variety of electronic measuring apparatus from a typical mercury thermometer. Infrared thermometer, such as forehead thermometer, ear thermometer, is the most precise and convenient one among these electronic measuring apparatus, and the Infrared thermometer has advantageous of high precision, easy operation and fast measuring, and it has become one of the mainstream methods of body measuring.

The medicine taken generally for common cold and illness requires body measuring before oral use, particularly for children and the elderly because they cannot react to the body temperature situation acutely as normal adults can, and thus these people need a thermometer to help themselves. Besides, fever is the central nervous system's failure of control to adjust the body temperature, or caused by external bacteria and/or virus that invades the human body to suffer a continuous high temperature so that the symptom has quickly developed, and might cause other complications that endanger lives. The general social and public sectors rely on the importance of body measuring, and if the body temperature can be provided as a front line control to prevent from missing the timing of medical protection, the need for thermometer is increased as well.

The pen-shaped electronic thermometer available in the market has such many features as quickly measuring the body temperature, LCD display for presentation, clearly indicating the temperature, and rendering the previous measuring temperature data in memory and alarm notice issued after the completion of temperature measuring, rather than the typical mercury thermometer which takes the risk of easily having fracture accidently so as to lead to mercury poisoning and contaminate the environment, and thus it has become an necessity widely used in ordinary families and hospitals, and its supply falls short of its demand as well. However, even the pen-shaped electronic thermometer still need to have such basic parts as battery, display, and memory, and thus the overall volume seems so large that it is not easy to carry.

### SUMMARY OF THE INVENTION

Therefore, it is a primary objective of the invention to propose an improved temperature measuring apparatus, and more particularly to an improved temperature measuring apparatus with easy carrying and timely measuring.

For the afore-mentioned purpose, the invention discloses an improved temperature measuring apparatus which at least comprises a temperature measurement device and a mobile electronic part. The temperature measurement device is provided with a temperature sensing unit, a signal processing unit and a first transmission unit. The signal processing unit is connected with the temperature sensing unit and the first transmission unit, respectively. The mobile electronic part is provided with a second transmission unit, a control unit, a display unit and a power supply. The control unit is connected with the second transmission unit, the display unit and the power supply, respectively, and the second transmission unit is connected with the first transmission unit.

Besides, a connection of the temperature measurement device with the mobile electronic part is formed by means of the first transmission unit and the second transmission unit. A temperature signal from the person under measurement is measured by means of the power supply of the mobile electronic part providing activation of the temperature measurement device, and it is transmitted to the mobile electronic part and then presented the signal on the display unit. Therefore, the present invention has such effects as easy operation, plug-and-play, and timely measuring.

### BRIEF DESCRIPTION OF THE DRAWINGS

FIG. 1 is a schematic 3D view that shows a structure of a temperature measuring apparatus according to the invention.

FIG. 2 is a schematic view that shows the structure of the temperature measuring apparatus according to the invention.

FIG. 3 is a schematic view that shows another structure of the temperature measuring apparatus according to the invention.

FIG. 4 is a schematic view that shows yet another structure of the temperature measuring apparatus according to the invention.

### DETAILED DESCRIPTION OF THE INVENTION

The features adopted by the present invention can be clearly understood by referring to the following detailed description of the preferred embodiments and the accompanying diagrams.

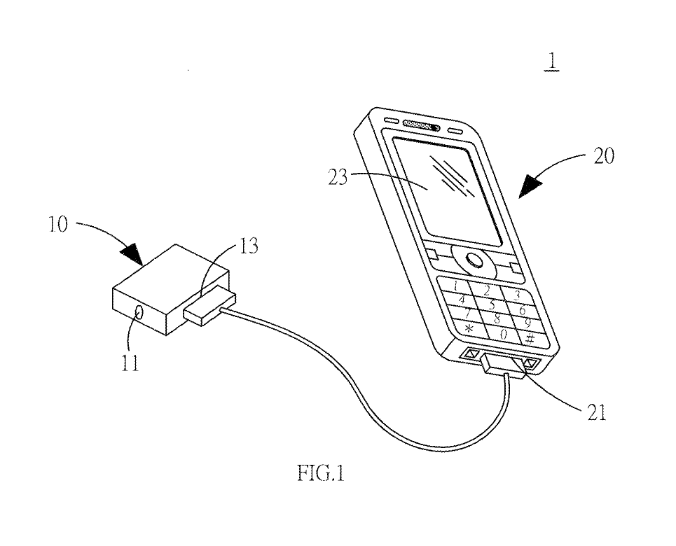

Refer to FIG. 1, which is a schematic 3D view that shows a structure of a temperature measuring apparatus according to the invention, and the improved temperature measuring apparatus 1 of the invention at least comprises a temperature measurement device 10 and a mobile electronic part 20.

The temperature measurement device 10 is provided with a temperature sensing unit 11, a signal processing unit 12 and a first transmission unit 13. The signal processing unit 12 is connected with the temperature sensing unit 11 and the first transmission unit 13, respectively. The temperature sensing unit 11 can be an infrared sensor, which is used to sense the body temperature signal of the person under measurement. The temperature detection theory of the invention is the same one as frequently seen in an ordinary electronic thermometer. The temperature signal will be converted into an electronic signal through any change in voltage, resistance or current generated by the thermal sensing.

The mobile electronic part 20 is provided with a second transmission unit 21, a control unit 22, a display unit 23 and a power supply 24. The control unit 22 is connected with the second transmission unit 21, the display unit 23 and the power supply 24, respectively. The second transmission unit 21 is connected with the first transmission unit 13. The mobile electronic part 20 can be a cell phone, a laptop, or a tablet PC, etc.

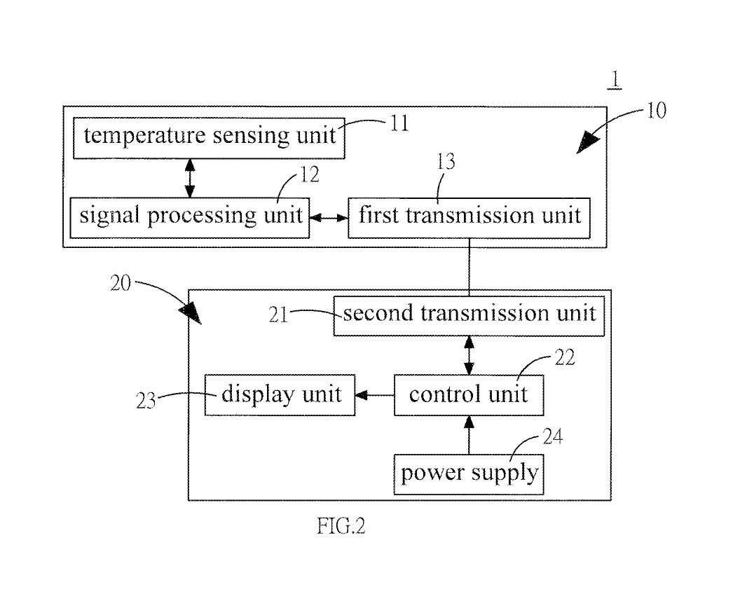

According to the example embodiments shown in FIG. 1 and FIG. 2, the temperature sensing unit 11 is disposed on an edge of the temperature measurement device 10, and the first transmission unit 13 and second transmission unit 21 are configured as a USB interface. In practice, a connection of the temperature measurement device 10 with the mobile electronic part 20 is formed by means of the first transmission unit 13 and the second transmission unit 21, and the power supply 24 of the mobile electronic part 20 provides activation of the temperature measurement device 10. The temperature sensing unit 11 is provided to contact the human skin, in the armpit, or under the tongue for measuring the body temperature, and the temperature sensing unit 11 transmits the measured body temperature value to the signal processing unit 12. The signal processing unit 12 transmits the value to the mobile electronic part 20 through the first transmission unit 13 and second transmission unit 21, and the value is presented on the display unit 23 in digital way.

The first transmission unit 13 and second transmission unit 21, shown in FIG. 1 and FIG. 2, are configured as a USB interface, of course, as a wireless connection, or the second transmission unit is an audio source jack of the mobile electronic part. Besides, the temperature sensing unit forms a thermopile by means of employing thin film technology in a silicon substrate to aggregate a plurality of thermal couples, and each of the thermal couples has a hot end and a cold end to form an insulation therebetween by using an insulated film of SiNx. The hot end is provided to convert introduced infrared into heat, and the thermal couples convert proportionally the heat into a voltage that is outputted to the signal processing unit. Besides, the temperature sensing unit can be an IC element for temperature sensing, and it utilizes the feature, such as negative temperature in PN junction semiconductor, and the barrier voltage can be decreased when the temperature increases such that the reverse current can be increased for temperature sensing.

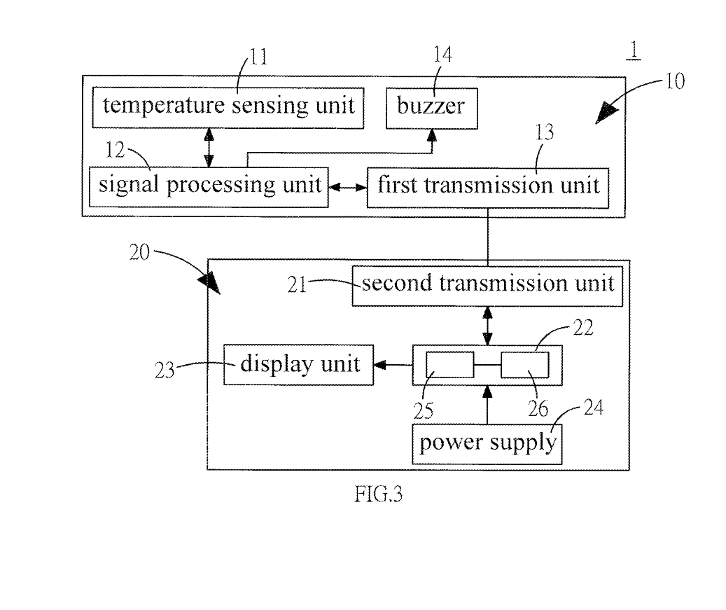

Besides, refer to FIG. 3, the temperature measurement device 10 is further provided with a buzzer 14 which is connected with the signal processing unit 12. The control unit 22 of the mobile electronic part 20 is provided with a comparison element 25 and a storage element 26. The comparison element 25 is provided to compare the current measured temperature data with the normal temperature, and release a “attention” or “danger” voice message via the buzzer 14, thus timely remind the measurer of early prevention. The storage element 26 is provided to store the measured temperature data such that family members or medical staff can judge and read the health conditions of the measurer as a reference through multiple measurements.

It is worthy of mention that the temperature measurement device of the invention has a small volume for convenient carry, and only requires a simple connection with the user's mobile electronic part during measurement such that it can achieve the effects of easy operation, plug-and-play, and timely measuring. Besides, the APP software applications can be downloaded to the mobile electronic part in advance for further utilizing the temperature measurements to record, administer, or integrate physiological conditions of multiple persons under measurement.

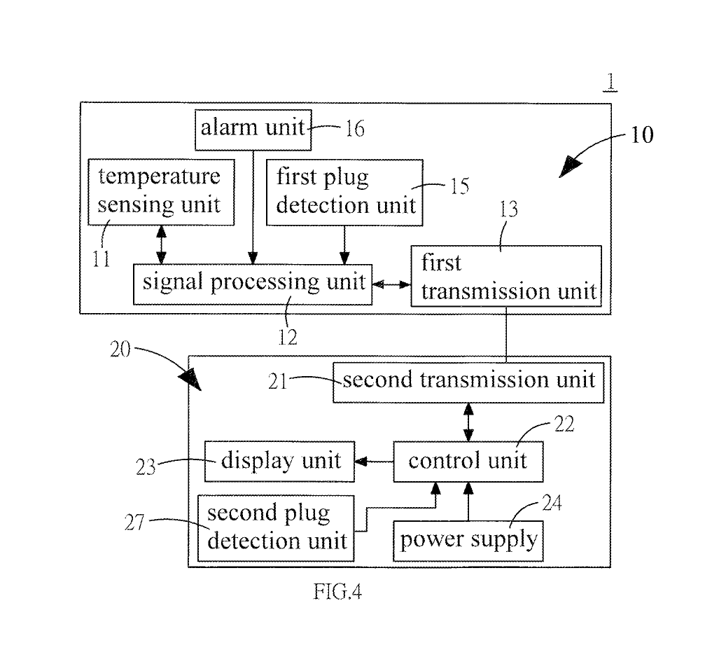

Besides, the temperature measurement device 10 is provided with a first plug detection unit 15 and an alarm unit 16, as shown in the embodiment of FIG. 4. The first plug detection unit 15 and the alarm unit 16 are connected with the signal processing unit 12, respectively. The first plug detection unit 15 can detect whether the first transmission unit 13 of the temperature measurement device 10 is connected with the second transmission unit 21, and control whether the alarm unit 16 sends an alarm or not via the signal processing unit 12. The alarm unit 16 can be a display light or buzzer. The mobile electronic part 20 is provided with a second plug detection unit 27. The second plug detection unit 27 is connected with the control unit 22. The second plug detection unit 27 can detect whether the first transmission unit 13 of the temperature measurement device is connected with the second transmission unit 21, and control whether the display unit 23 performs a display via the control unit 22. For instance, when the temperature measurement device 10 is plugged to the mobile electronic part 20, the first plug detection unit 15 and the second plug detection unit 27 can detect respectively and confirm that the temperature measurement device 10 is securely plugged to the mobile electronic part 20, and the alarm unit 16 can send an alarm to notice the user about the plug-in status.

Although a preferred embodiment of the invention has been described for purposes of illustration, it is understood that various changes and modifications to the described embodiment can be carried out without departing from the scope and the spirit of the invention as disclosed in the following appended claims.

What is claimed is:

1. An improved temperature measuring apparatus, at least comprising:
a temperature measurement device, provided with a temperature sensing unit, a signal processing unit and a first transmission unit, said signal processing unit being connected with said temperature sensing unit and said first transmission unit, respectively; and
a mobile electronic part, provided with a second transmission unit, a control unit, a display unit and a power supply, wherein said control unit is connected with said second transmission unit, the display unit and the power supply, respectively; wherein said second transmission unit is connected with said first transmission unit so as to receive a measurement result from said temperature measurement device.

2. The improved temperature measuring apparatus of claim 1, wherein said first transmission unit and second transmission unit are configured as a USB interface, respectively.

3. The improved temperature measuring apparatus of claim 1, wherein said first transmission unit and second transmission unit are configured as a wireless connection, respectively.

4. The improved temperature measuring apparatus of claim 1, wherein said temperature measurement device is further provided with a buzzer, said buzzer being connected with said signal processing unit.

5. The improved temperature measuring apparatus of claim 1, wherein said control unit is provided with a comparison element and a storage element.

6. The improved temperature measuring apparatus of claim 1, wherein said second transmission unit is an audio source jack of said mobile electronic part.

7. The improved temperature measuring apparatus of claim 1, wherein said temperature measurement device is provided with a first plug detection unit and an alarm unit, said first plug detection unit and said alarm unit being connected with said signal processing unit, respectively, so as to enable said first plug detection unit to detect whether said first transmission unit of said temperature measurement device is connected with said second transmission unit, and to control whether said alarm unit sends an alarm by means of said signal processing unit.

8. The improved temperature measuring apparatus of claim 7, wherein said alarm unit is a display light or buzzer.

9. The improved temperature measuring apparatus of claim 1, wherein said mobile electronic part is provided with a second plug detection unit, said second plug detection unit being connected with said control unit, so as to enable said second plug detection unit to detect whether said first transmission unit of said temperature measurement device is connected with said second transmission unit, and to control whether said display unit performs a display by means of said control unit.

10. The improved temperature measuring apparatus of claim 1, wherein said temperature sensing unit forms a thermopile by means of employing thin film technology in a silicon substrate to aggregate a plurality of thermal couples wherein each of said thermal couples has a hot end and a cold end to form an insulation therebetween by using an insulated film of SiNx, employing said hot end to convert introduced infrared into heat, said thermal couples converting proportionally said heat into a voltage that is outputted to said signal processing unit.

11. The improved temperature measuring apparatus of claim 1, wherein said temperature sensing unit is an IC element for temperature sensing.
